(19) United States
(12) Patent Application Publication
(10) Pub. No.: US 2016/0200583 A1
(43) Pub. Date: Jul. 14, 2016

(54) CHEMICAL ACTIVATION OF CARBON USING RF AND DC PLASMA

(71) Applicant: CORNING INCORPORATED, Corning, NY (US)

(72) Inventors: Daniel Robert Boughton, Naples, NY (US); James Gerard Fagan, Painted Post, NY (US)

(21) Appl. No.: 14/906,425

(22) PCT Filed: Jul. 21, 2014
(86) PCT No.: PCT/US2014/047386

§ 371 Date: Jan. 20, 2016

Related U.S. Application Data
(60) Provisional application No. 61/858,869, filed on Jul. 26, 2013.

(51) Int. Cl. C01B 31/12; B01J 19/08; C01B 31/08

(52) U.S. Cl. CPC C01B 31/12; C01B 31/088; B01J 19/088; B01J 2219/0805; B01J 2219/0869; B01J 2219/0871; B01J 2219/0879; B01J 2219/0894

(57) ABSTRACT

The disclosure relates to methods and apparatuses for forming activated carbon from feedstock particles comprising a carbon feedstock and at least one activating agent. The feedstock particles are contacted with a plasma plume generated by the combination of RF and DC power sources. The feedstock particles may flow in a cyclonic pattern in the plasma plume for increased residence time. The carbon feedstock may be a carbon precursor material or a carbonized material. The feedstock particles are contacted with the plasma plume at a temperature and for a time sufficient to carbonize and/or activate the feedstock particles.

### CROSS-REFERENCE TO RELATED APPLICATIONS

This application claims the benefit of priority under 35 U.S.C. §119 of U.S. Provisional Application Ser. No. 61/858,869 filed on Jul. 26, 2013, the content of which is relied upon and incorporated herein by reference in its entirety.

### FIELD OF THE DISCLOSURE

The present disclosure relates generally to methods and apparatuses for forming activated carbon, and more particularly to chemical activation of carbon using RF and DC plasma.

### BACKGROUND

Energy storage devices such as ultracapacitors may be used in a variety of applications, ranging from cell phones to hybrid vehicles. Ultracapacitors have emerged as an alternative to batteries in applications that require high power, long shelf life, and/or long cycle life. Ultracapacitors typically comprise a porous separator and an organic electrolyte sandwiched between a pair of carbon-based electrodes. The energy storage is achieved by separating and storing electrical charge in the electrochemical double layers that are created at the interfaces between the electrodes and the electrolyte. Important characteristics of these devices are the energy density and power density that they can provide, which are both largely determined by the properties of the carbon that is incorporated into the electrodes.

Carbon-based electrodes suitable for incorporation into energy storage devices are known. Activated carbon is widely used as a porous material in ultracapacitors due to its large surface area, electronic conductivity, ionic capacitance, chemical stability, and/or low cost. Activated carbon can be made from natural precursor materials, such as coals, nut shells, and biomass, or synthetic materials such as phenolic resins. With both natural and synthetic precursors, the activated carbon can be formed by carbonizing the precursor and then activating the intermediate product. The activation can comprise physical (e.g., steam or CO₂) or chemical activation at elevated temperatures to increase the porosity and hence the surface area of the carbon.

Both physical and chemical activation processes typically involve large thermal budgets to heat and react the carbonized material with the activating agent. In the case of chemical activation, corrosive by-products can be formed when a carbonized material is heated and reacted with an activating agent such as KOH. Additionally, phase changes, or fluxing, that may occur during the heating and reacting of the carbonized material and activating agent can result in agglomeration of the mixture during processing. These drawbacks can add complexity and cost to the overall process, particularly for reactions that are carried out at elevated temperatures for extended periods of time.

Significant issues have been reported when caustics, such as KOH, are used for the chemical activation of carbon. For example, when rotary kilns are used in carbon activation, it is often required that the feedstock undergoes calcination and/or drying and/or dehydration prior to treatment at activation temperatures. Agglomeration tends to pose significant issues, such as increased process complexity and/or cost, in continuous processes, for instance, processes employing screw kneaders.

As a means to avoid agglomeration issues, other technologies such as roller hearths, have been employed wherein trays are loaded with activation mix material and passed through a multiple zone tunnel furnace. Such furnaces may be costly in operation and may have limited throughput since only one tray level is passed through the furnace at a time. The furnace width is also a limiting factor for roller hearths on throughput, since roller length spanning across the furnace is limited by material availability and strength at service temperature. Additionally, current methods for activating carbon typically employ a batch process, semi-batch process, or continuous process with a slow feed rate, all of which take significant amounts of time and energy.

Accordingly, it would be advantageous to provide activated carbon materials and processes for forming activated carbon materials using a faster and more economical chemical activation route, while also minimizing the issues relating to corrosion and/or agglomeration. The resulting activated carbon materials can possess a high surface area to volume ratio and can be used to form carbon-based electrodes that enable efficient, long-life and high energy density devices.

### SUMMARY

The disclosure relates, in various embodiments, to an apparatus for the chemical activation of carbonaceous materials, comprising a plasma plume generated by the combination of radio-frequency (RF) current and direct current (DC) power sources. Various dispensers are included to introduce feedstock particles, comprising a carbon feedstock and at least one activating agent, into the plasma plume. In various embodiments, a flow of at least one gas having a direction tangential to the plasma plume is utilized to incite a cyclonic flow of particles within the plasma plume.

Also disclosed herein are methods for forming activated carbon, comprising contacting the feedstock particles with the plasma plume for a residence time sufficient to react the carbon feedstock with the at least one activating agent to form activated carbon. In certain embodiments, a cyclonic flow of particles within the plasma plume is produced to increase residence time.

According to various non-limiting embodiments, the activating agent is an alkali metal hydroxide, such as KOH, NaOH, or LiOH. In other embodiments, the carbon feedstock is chosen from carbon precursor materials and carbonized materials.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

The following detailed description can be best understood when read in conjunction with the following drawings, where like structures are indicated with like reference numerals and in which:

FIG. 1 is an estimated equilibrium phase diagram for KOH and carbon in a closed system;

FIG. 2 is a schematic illustration of a system for preparing activated carbon according to one embodiment of the disclosure; and

FIG. 3 is a schematic illustration of a system for preparing activated carbon according to one embodiment of the disclosure.

### DETAILED DESCRIPTION

Disclosed herein is an apparatus for the chemical activation of carbonaceous materials, comprising (i) a plasma containment vessel, (ii) a coil disposed around the plasma containment vessel and configured for current flow within the coil, (iii) a plasma delivery vessel connected to the plasma containment vessel, (iv) a first dispenser disposed to introduce a first stream comprising a first gas and feedstock particles into the plasma containment vessel, wherein the feedstock particles comprises a carbon feedstock and, optionally, at least one activating agent, (v) a second dispenser disposed to introduce a tangential flow of a second gas into the plasma delivery vessel, (vi) an optional third dispense disposed to introduce the at least one activating agent into the plasma delivery vessel, (vii) a radio-frequency generator connected to the at least one coil and configured to produce a radio-frequency current flow within the coil, and (viii) a direct current supply connected to the plasma containment vessel, wherein the radio-frequency and direct currents together are sufficient to convert the first gas into a plasma and wherein the at least one activating agent is introduced by the first dispenser and/or the third dispenser.

Also disclosed herein is a method for making activated carbon, comprising (i) generating a plasma plume and (ii) introducing feedstock particles comprising a carbon feedstock and at least one activating agent into the plasma plume, wherein the feedstock particles flow in a cyclonic pattern within the plasma plume and wherein the feedstock particles are in contact with the plasma plume for a time sufficient to react the carbon feedstock with the at least one activating agent to form activated carbon.

The apparatuses and methods disclosed herein can also be used for the physical activation of carbon, e.g., without the use of a chemical activating agent. For instance, carbon feedstock particles can be introduced into the plasma plume in the presence of one or more gases, such as steam and/or carbon dioxide, wherein the carbon feedstock particles flow in a cyclonic pattern within the plasma plume and are in contact with the plume for a time sufficient to activate the carbon. In such non-limiting embodiments, the feedstock particles comprise carbon feedstock without any activating agent and the optional third dispenser in the apparatus is either absent or is used to dispense an additional gas, such as steam and/or carbon dioxide. Similar arrangements suitable for the physical activation of carbon are envisioned and intended to be encompassed by the present disclosure.

Materials

According to various embodiments, the carbon feedstock may comprise carbon precursor materials, carbonized materials, and mixtures thereof. Exemplary carbon precursors include natural materials such as nut shells, wood, biomass, non-lignocellulosic sources, and synthetic materials, such as phenolic resins, including poly(vinyl alcohol) and (poly)acrylonitrile. For instance, the carbon precursor can be chosen from edible grains such as wheat flour, walnut flour, corn flour, corn starch, corn meal, rice flour, and potato flour. Other non-limiting examples of carbon precursors include coconut husks, beets, millet, soybean, barley, and cotton. The carbon precursor can be derived from a crop or plant that may or may not be genetically-engineered. Carbonized materials may include, for example, coal, or any carbonized material derived from a carbon precursor material disclosed herein.

Further exemplary carbon precursor materials and associated methods of forming carbonized materials are disclosed in commonly-owned U.S. Pat. Nos. 8,198,210, 8,318,356, and 8,482,901, and U.S. Patent Application Publication No. 2010/0150814, all of which are incorporated herein by reference in their entireties.

Carbon precursor materials can be carbonized to form a carbon feedstock by heating in an inert or reducing atmosphere. Examples of inert or reducing gases and gas mixtures include one or more of hydrogen, nitrogen, ammonia, helium and argon. In an example process, a carbon precursor can be heated at a temperature from about 500° C. to about 950° C. (e.g., about 500, 550, 600, 650, 700, 750, 800, 850, 900 or 950° C., and all ranges and subranges therebetween) for a predetermined time (e.g., about 0.5, 1, 2, 4, 8 or more hours, and all ranges and subranges therebetween) and then optionally cooled. During carbonization, the carbon precursor may be reduced and decomposed to form carbon feedstock.

In various embodiments, the carbonization may be performed using a conventional furnace or by heating within a microwave reaction chamber using microwave energy. For instance, a carbon precursor can be exposed to microwave energy such that it is heated and reduced to char within a microwave reactor to form carbon feedstock that is then combined with an activating agent to form a feedstock mixture. It is envisioned that a single carbon precursor material or combination of precursor materials could be used to optimize the properties of the activated carbon product.

According to a further embodiment, the carbonization may be performed simultaneously with the activation, for instance, when the carbon feedstock is contacted with the plasma plume. In this embodiment, the carbon feedstock comprises carbon precursor materials, e.g., non-carbonized carbonaceous materials. In yet a further embodiment, the carbon feedstock is a carbonized material, e.g., it will undergo little or no carbonization in the plasma plume.

The at least one activating agent may, in certain embodiments, be chosen from KOH, NaOH, H₃PO₄, Na₂CO₃, KCl, NaCl, MgCl₂, KOH, AlCl₃, P₂O₅, K₂CO₃, and/or ZnCl₂. According to various non-limiting embodiments, the at least one activating agent may be chosen from alkali metal salts, for instance, alkali metal hydroxides such as sodium hydroxide, lithium hydroxide, and/or potassium hydroxide.

Methods

The term “feedstock particles” and variations thereof are used herein to denote particles of carbon feedstock, particles of at least one activating agent, particles of a carbon feedstock coated or otherwise combined with at least one activating agent, or any combination of these. A combination or mixture, of whatever form and in whatever place occurring, of particles of a carbon feedstock with at least one activating agent is referred to herein as a “feedstock mixture.”

A feedstock mixture may be prepared by any method known that combines the carbon feedstock with the at least one activating agent. For example, in certain non-limiting embodiments, an aqueous solution may be used, and the concentration of activating agent in the solution may range from about 10 to about 90 wt %. The activating agent solution may be room temperature or may be heated. In further embodiments, the carbon feedstock can be combined with the at least one activating agent to form a dry feedstock mixture, e.g., without the use of any liquid or solvent.

The carbon feedstock and the at least one activating agent may be combined and/or separately introduced into the plasma plume in any suitable ratio to form the feedstock mixture and to bring about chemical activation of the carbon. The specific value of a suitable ratio may depend, for example, on the physical form and type of the carbon feedstock and the activating agent and the concentration, if one or both are in the form of a mixture or solution. A ratio of activating agent to carbon feedstock on the basis of dry material weight can range, for example, from about 0.5:1 to about 5:1. For example, the ratio can range from about 1:1 to about 4:1, or from about 2:1 to about 3:1, including all ranges and subranges therebetween. In certain embodiments, the mass ratio of activating agent to carbon feedstock may be about 1:1, 2:1, 3:1, 4:1, or 5:1, including all ranges and subranges therebetween. According to other embodiments, the mass ratio of activating agent to carbon feedstock may be less than about 12:1, for instance, less than about 11:1, less than about 10:1, or less than about 8:1, including all ranges and subranges therebetween.

The feedstock particles may be further prepared by milling or grinding the particles. For example, the carbon feedstock and/or the at least one activating agent may be separately milled and then optionally mixed together. In other embodiments, the feedstock mixture may be simultaneously milled during mixing of the carbon feedstock and at least one activating agent. According to further embodiments, the feedstock mixture may be milled after the carbon feedstock and at least one activating agent are mixed together.

Optional granulation steps may include mixing the carbon feedstock with the at least one activating agent, optionally with heating, by way of roll compaction, drum pelletization, vacuum drying, freeze drying, and/or any other means suitable for mixing and/or granulating the feedstock mixture. Additionally, granulation may be accomplished using binder additives such as CARBOWAX (Dow Chemical), a paraffin wax which may decompose with little or no residue contamination of the activated carbon. Use of such binders may also be employed in granulation methods including, but not limited to, pelletizing via roll compaction, drum pelletizing, and/or extrusion mixing and/or grating.

By way of non-limiting example, the feedstock particles may be milled to an average particle size of less than about 100 microns, for instance, less than about 100, 50, 25, 10, or 5 microns, and all ranges and subranges therebetween. In various embodiments, the feedstock mixture can have an average particle size of less than about 5 microns, such as less than about 4, 3, 2, or 1 microns, and all ranges and subranges therebetween. In further embodiments, the average particle size of the carbon feedstock mixture may range from about 0.5 to about 25 microns, such as from about 0.5 microns to about 5 microns.

In additional embodiments, the feedstock particles may be further prepared by pre-heating the particles. By way of non-limiting example, the feedstock particles may be pre-heated during and/or after mixing and/or milling the mixture. In these embodiments, the feedstock particles may be pre-heated to any temperature below the fluxing temperature of the mixture. For instance, the feedstock may be heated to a temperature of less than about 400° C., such as less than about 350, 300, 250, 200, or 100° C., and all ranges and subranges therebetween. According to various embodiments, the feedstock may be heated to a temperature ranging from about 50° C. to about 400° C., such as from about 50° C. to about 150° C., from about 90° C. to about 120° C., from about 200° C. to about 400° C., or from about 300° C. to about 400° C., including all ranges and subranges therebetween.

The carbon feedstock and the at least one activating agent may be introduced into the plasma plume together as a feedstock mixture or separately as independent components. For instance, in one embodiment, a feedstock mixture comprising the carbon feedstock and the at least one activating agent is introduced into the plasma plume. In another embodiment, the carbon feedstock and the activating agent are introduced into the plasma plume separately, e.g., at different locations in the plasma plume. According to a further embodiment, the feedstock mixture may be introduced into the plasma plume along with the separate introduction of additional activating agent. The additional activating agent may, in certain aspects, be the same or different from the activating agent used in the feedstock mixture.

The feedstock particles may be introduced into the plasma plume in a stream of a first gas which may, in various embodiments, be chosen from ambient air and inert gases such as nitrogen, argon, helium, and mixtures thereof. The feedstock components may be entrained in the first gas such that the particles are floating freely within the stream of gas. It will be appreciated that alkali metals, for example, sodium and potassium, may spontaneously combust upon exposure to air. Formation of alkali metals can be prevented or alleviated by introducing steam as a component of the first gas. For example, mixtures of steam with air, nitrogen, argon, and/or helium are envisioned. Alternatively, the feedstock particles may be introduced in the first stream as an aqueous mixture. The water vapor will scavenge alkali atoms and react to form non-combustible alkali oxides or hydroxides. Thus, in certain embodiments, steam or water vapor entrained in an inert gas, such as nitrogen or argon, can be introduced into the plasma plume.

The first stream may be at ambient temperature or it may optionally be heated. By way of non-limiting example, the first gas may have a temperature ranging from about 25° C. to about 400° C., such as from about 50° C. to about 350° C., from about 100° C. to about 300° C., or from about 150° C. to about 250° C., including all ranges and subranges therebetween. The feed rate of the first stream may range, for example, from about 10 SLPM to about 200 SLPM, for example, from about 30 SLPM to about 150 SLPM, or from about 50 to about 100 SLPM, including all ranges and subranges therebetween. It is within the ability of one skilled in the art to select the feed rate appropriate for the desired operation and result.

According to various embodiments, the feedstock particles are rapidly heated by contact with the plasma plume. The plasma plume may be envisioned as having a substantially cylindrical or slightly conical shape, with a given length and a circular cross-section. The circular cross-section is defined by the center, or core, and various concentric rings or sheaths. The temperature of the plasma plume may thus be described as a cross-sectional gradient, where the core of the plasma plume can have a temperature of at least about 11,000° K and the outer sheath or outer edge of the plasma plume stream may have a relatively lower temperature of at least about 300° K. For instance, the core may have a temperature ranging from about 9,000° K to about 11,000° K and the outer sheath may have a temperature ranging from about 300° K to about 1,000° K, such as from about 300° K to about 500° K. The plasma plume may be generated using various heating methods, for example, dielectric (RF) heating, direct current (DC) heating, and combinations thereof.

The feedstock particles, upon introduction into the plasma plume, may flow in a cyclonic pattern along the length of the plume. By way of non-limiting example, a second stream of a second gas may be introduced into the plasma plume, in a direction tangential to the flow of the plasma plume. The angle of introduction may vary depending on the apparatus, but may generally range from about 15° to about 90°, relative to the flow of the plasma, e.g., relative to the flow along the length of the plasma plume. The cyclonic flow within the plume serves not only to lengthen the residence time of the feedstock particles in the plasma but also generates a centrifugal force which drives the feedstock particles to the cooler outer edges of the plasma plume. Once the particles reach the desired activation temperature, the cyclonic action, together with the forward velocity of the plasma plume, may also drive the particles out of the plasma plume into a collection chamber.

Without wishing to be bound by theory, in at least certain embodiments, it is believed that the use of a plasma plume will rapidly heat the feedstock particles through the theoretical fluxing temperature range and up to the activation temperature, in a time period sufficient so as to avoid the formation of a liquid phase. According to various embodiments, the residence time within the plasma plume may be less than about 10 seconds, for instance, less than about 5 seconds, less than about 1 second, less than about 0.5 seconds, or less than about 0.1 seconds. In other embodiments, the rapid heating of the feedstock particles may occur within milliseconds, for example, the time period may range from about 0.01 to about 0.09 seconds. In certain non-limiting embodiments, the plasma plume heats the feedstock particles to an activation temperature, which may range, for example, from about 600° C. to about 900° C., such as from about 650° C. to about 850° C., or from about 700° C. to about 800° C., or from about 750° C. to about 900° C., including all ranges and subranges therebetween.

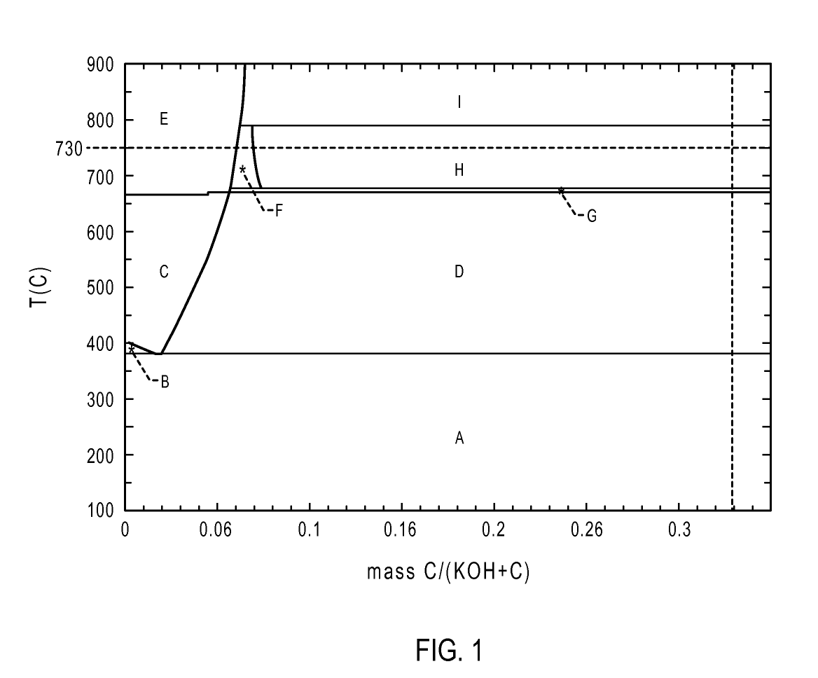

The term “fluxing temperature” and variations thereof are intended to denote a temperature at which at least one solid to liquid transformation results in the introduction of at least one liquid phase in the bulk feedstock mixture, wherein the solid to liquid transformation is associated with an increase in temperature. Similarly, the term “solidification temperature” and variations thereof are intended to denote a temperature at which at least one liquid to solid transformation results in a substantially liquid-free, e.g., substantially solid bulk mixture, wherein the liquid to solid transformation is associated with an increase in temperature. The fluxing and solidification temperatures are described in more detail with reference to FIG. 1.

Referring to FIG. 1, which illustrates an estimated equilibrium phase diagram for KOH and carbon in a closed system, it is noted that the exemplified feedstock mixture undergoes several phase changes at different theoretical temperatures and carbon/KOH ratios. The different phases are depicted in FIG. 1, with reference to Regions A-I described below in Table I:

TABLE I
Theoretical Regions A-I

| | Theoretical Temperature | |
|---|---|---|
| Region | (approximate) | Phases |
| A | 0-375° C. | C(s) + KOH(s) |
| B | 375-400° C. | liq soln + K(I) + KOH(s) |
| C | 400-660° C. | liq soln + K(I) |
| D | 375-660° C. | liq soln + K(I) + C(s) |
| E | 660-900° C. | liq soln |
| F | 680-800° C. | liq soln + K₂CO₃(s) |
| G | 660-680° C. | liq soln + C(s) |
| H | 680-800° C. | C(s) + K₂CO₃(s) |
| I | 800-900° C. | liq soln + C(s) |

For instance, in the case of KOH, for the illustrated compositions in theoretical equilibrium, the closed system exists as two solid phases (Region A) up to approximately 375° C. Above about 375° C., which is the approximate fluxing temperature, KOH melts and a plurality of liquid phases are prominent in each of Regions B, C, and D. Typically, carbon activation occurs at conditions within Region H of FIG. 1 (e.g., for compositions having a C(C+KOH) mass ratio of at least about 0.08 and at a temperature ranging from about 680° C. to about 800° C.).

The intersecting dashed lines in FIG. 1 serve to illustrate an exemplary set of process parameters, e.g., T=730° C. and C/(C+KOH)=0.33 (or KOH:C=2:1), which may be employed in the methods disclosed herein and are not intended to be limiting in any way. It is to be understood that the fluxing and solidification temperatures may vary depending on the activating agent or mixture of agents used. It is within the ability of one skilled in the art to identify these temperatures for any feedstock particles as defined herein.

It will also be understood by those skilled in the art that the methods and processes disclosed herein may, in various embodiments, function under non-equilibrium conditions. In such cases, it is noted that the actual or observed fluxing and/or solidification temperatures may vary from those predicted by the model in FIG. 1. For instance, as indicated in Table II below, the experimentally observed values for the KOH/carbon system may be lower than those predicted by the theoretical model. The experimental data provided below is for exemplary purposes only and is not intended to limit or otherwise define the scope of the instant disclosure. It is within the ability of those skilled in the art to obtain similar experimental values for other activating agents disclosed herein and mixtures of such activating agents.

TABLE II
Experimental Regions A-G

| | Experimental | | |
|---|---|---|---|
| | Temperature | Observed | |
| Region | (approximate) | Mixture State | Potential Reactions |
| A | 0-120° C. | Solid | Heating |
| B | 120-150° C. | Solid to liquid | KOH•(xH₂O)(s)→KOH(I) + |
| | | | H₂O(g) |
| C | 150-200° C. | Liquid | KOH•(xH₂O)(s)→KOH(I) + |
| | | | H₂O(g) |
| D | 200-400° C. | Low viscosity | 2KOH(I)→K₂O(s) + H₂O(g) |
| | | liquid | |
| E | 400-500° C. | Thick viscous | 6KOH(I) + C(s) → 2K(s) + |
| | | slurry | 3H₂(g) + 2K₂CO₃(s) |
| F | 500-600° C. | Solid | 6KOH(I) + C(s) → 2K(s) + |
| | | | 3H₂(g) + 2K₂CO₃(s) |
| G | 600-750° C. | Solid | K₂CO₃(s) → K₂O(s) + |
| | | | CO₂(g) |

As illustrated in Table II above, the observed experimental fluxing temperature of a KOH/carbon system can be as low as 120° C., at which point the KOH begins melting or undergoing a phase transformation from solid to liquid. Similarly, the solidification temperature of the KOH/carbon system can be as low as 500° C., at which point the feedstock mixture undergoes at least one liquid to solid transformation which results in a substantially liquid-free, e.g., substantially solid bulk mixture. Activation may likewise occur at temperatures lower than theoretical values, such as greater than about 500°, or greater than about 600° C. According to various embodiments herein, when KOH is the activating agent, the feedstock particles are rapidly heated to the activation temperature in a time period sufficient to maintain the feedstock mixture in a substantially solid state. In other words, the feedstock mixture is rapidly heated through the observed KOH fluxing temperature range (Regions B-E, approximately 120-500° C.), in a time period sufficient so as to avoid the solid-liquid transformation and the formation of a liquid phase.

Without wishing to be bound by theory, it is believed that a sufficiently short residence time in the fluxing temperature range can retain the feedstock mixture in a substantially dry, e.g., substantially solid state as it is heated to the activation temperature. For example, the rapid thermal transfer achieved using plasma may avoid the regions in which the activating agent, such as KOH, melts or undergoes a phase transition from solid to liquid. In the case of KOH as activating agent, the feedstock particles may be optionally pre-heated up to less than about 375° C. (the theoretical fluxing temperature) and rapidly heated up to the activation temperature when contacted with the plasma, followed by a holding time at a temperature sufficient to activate the carbon, as discussed herein. In other embodiments, the feedstock mixture may be optionally pre-heated up to approximately 120° C. (the experimental fluxing temperature) and rapidly heated up to the activation temperature when contacted with the plasma, followed by an optional holding time at the activation to further activate the carbon, if desired.

An activating agent such as KOH can interact and react with carbon such that the potassium ion is intercalated into the carbon structure and potassium carbonate is formed. The reaction kinetics for both of these processes is believed to increase at elevated temperatures, which can lead to a higher rate of activation. As used herein, the term “activation” and variations thereof refer to a process whereby the surface area of carbon is increased such as through the formation of pores within the carbon.

According to various embodiments, the carbon feedstock particles are completely activated during the residence time in the plasma plume. The activated carbon particles may then be collected and optionally further processed, as discussed herein. In other embodiments, the feedstock particles may be partially activated during contact with the plasma plume, but it may be desirable to further process them to increase the degree of activation. In this embodiment, upon exiting the plasma plume, the activated carbon particles may be collected and introduced into a reaction vessel, where they are held at the activation temperature for an additional time sufficient to achieve the desired level of activation. According to various embodiments, the feedstock is held for an additional time ranging from about 5 minutes to about 6 hours, for instance, from about 5 minutes to about 1 hour, or from about 10 minutes to about 40 minutes, including all ranges and subranges therebetween. The temperature in the reaction vessel may range, for example, from about 600° C. to about 900° C., such as from about 700° C. to about 900° C., or from about 680° C. to about 800° C., including all ranges and subranges therebetween.

The reaction vessel may be chosen, for example, from fluid bed reactors, rotary kiln reactors, tunnel kiln reactors, crucibles, microwave reaction chambers, or any other reaction vessel suitable for heating and maintaining the feedstock at the desired temperature for the desired period of time. Such vessels can operate in batch, continuous, or semi-continuous modes. In at least one embodiment, the reaction vessel operates in continuous mode, which may provide certain cost and/or production advantages. Because the feedstock particles can be in a substantially solid state, it is believed that the potential for agglomeration may be significantly decreased, thereby impacting material flowability to a much smaller degree versus other conventional processes.

Microwave heating can also be employed to heat the reaction vessel. A microwave generator can produce microwaves having a wavelength from 1 mm to 1 m (frequencies ranging from 300 MHz to 300 GHz), though particular example microwave frequencies used to form activated carbon include 915 MHz, 2.45 GHz, and microwave frequencies within the C-band (4-8 GHz). Within a microwave reaction chamber, microwave energy can be used to heat a feedstock mixture to a predetermined temperature via a predetermined thermal profile.

In the case of microwave heating, batch processes can include loading the feedstock mixture into a crucible that is introduced into the microwave reaction chamber. Suitable crucibles include those that are compatible with microwave processing and resistant to alkali corrosion. Exemplary crucibles can include metallic (e.g., nickel) crucibles, silicon carbide crucibles or silicon carbide-coated crucibles such as silicon carbide-coated mullite. Continuous feed processes, may include, for example, fluid bed, rotary kiln, tunnel kiln, screw-fed, or rotary-fed operations. Carbon material in the form of a feedstock mixture can also be activated in a semi-continuous process where crucibles of the feedstock mixture are conveyed through a microwave reactor during the acts of heating and reacting.

As the activated carbon exits the collection vessel and/or reaction vessel, it can be held in a quench tank where it is cooled to a desired temperature. For instance, the activated carbon may be quenched using a water bath or other liquid or gaseous material. An additional benefit to quenching with water may include potential neutralization of unreacted alkali metals to minimize potential corrosion and/or combustion hazards. A rotary cooling tube or cooling screw may also be used prior to the quench tank.

After activation and quenching, the activated carbon can be optionally ground to a desired particle size and then washed in order to remove residual amounts of carbon, retained activating agents, and any chemical by-products derived from reactions involving the activating agent. As noted above, the activated carbon can be quenched by rinsing with water prior to grinding and/or washing. The acts of quenching and washing can, in some embodiments, be combined.

The activated carbon may be washed and/or filtered in a batch, continuous, or semi-continuous manner and may take place at ambient temperature and pressure. For example, washing may comprise rinsing the activated carbon with water, then rinsing with an acid solution, and finally rinsing again with water. Such a washing process can reduce residual alkali content in the carbon to less than about 200 ppm (0.02 wt %). In certain embodiments, after quenching and/or rinsing, the activated carbon is substantially free of the at least one activating agent, its ions and counterions, and/or its reaction products with the carbon. For instance, in the case of KOH as the activating agent, the activated carbon is substantially free of KOH, K⁺, OH⁻, and K₂CO₃. Accordingly, it is believed that the activating agent intercalates into the carbon and is then removed, leaving behind pores, increasing the surface area and activating the carbonaceous feedstock.

The activated carbon can comprise micro-, meso- and/or macroscale porosity. As defined herein, microscale pores have a pore size of about 2 nm or less and ultra-microscale pores have a pore size of about 1 nm or less. Mesoscale pores have a pore size ranging from about 2 to about 50 nm. Macroscale pores have a pore size greater than about 50 nm. In one embodiment, the activated carbon comprises a majority of microscale pores.

As used herein, the term “microporous carbon” and variants thereof means an activated carbon having a majority (e.g., greater than 50%) of microscale pores. A microporous, activated carbon material can comprise greater than 50% microporosity (e.g., greater than about 50, 55, 60, 65, 70, 75, 80, 85, 90 or 95% micro porosity). According to certain embodiments, the activated carbon may have a total porosity of greater than about 0.2 cm³/g (e.g., greater than about 0.2, 0.25, 0.3, 0.35, 0.4, 0.45, 0.5, 0.55, 0.6, 0.65 or 0.7 cm³/g). The portion of the total pore volume resulting from micropores (d 2 nm) can be about 90% or greater (e.g., at least about 90, 94, 94, 96, 98 or 99%) and the portion of the total pore volume resulting from micropores (d 1 nm) can be about 50% or greater (e.g., at least about 50, 55, 60, 65, 70, 75, 80, 85, 90 or 95%).

Apparatus

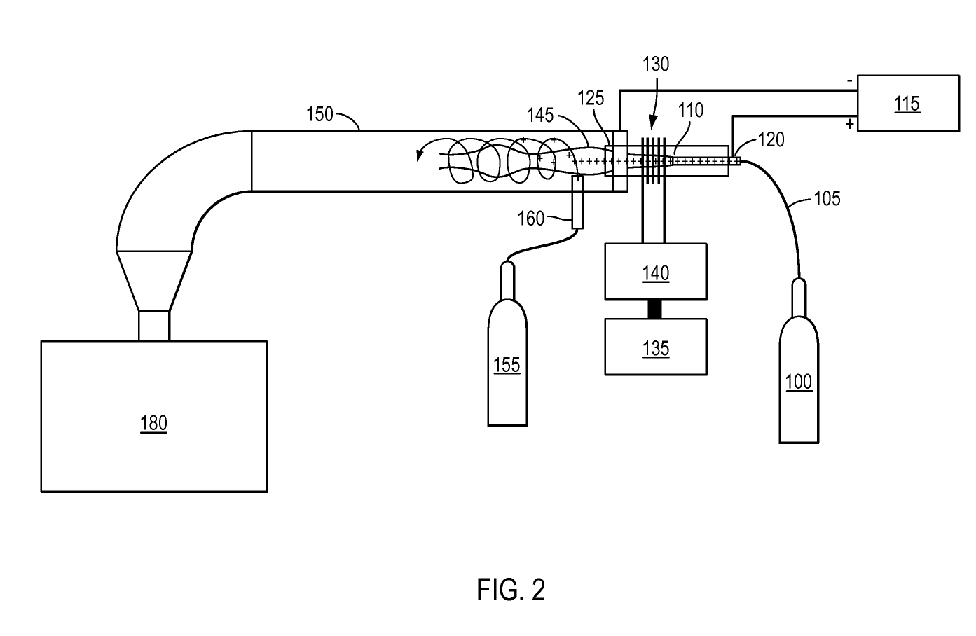

FIG. 2 illustrates an exemplary system operable for carrying out a method according to the present disclosure. In this embodiment, a first gas 100 and feedstock particles 105 comprising a carbon feedstock and at least one activating agent are combined and introduced into a plasma containment vessel 110. A DC supply 115 is connected to the plasma containment vessel 110 by way of an electrode having a positive terminal 120 and negative terminal 125. A coil 130 is disposed around the plasma containment vessel 110 and is attached to an RF plasma generator 135 by way of an RF plasma matchwork 140. The RF plasma generator 135 and DC supply 115 together serve to convert the first gas 105 into a plasma plume 145, which is directed into the plasma delivery vessel 150. The feedstock particles 105 (the flow of which is also illustrated by the “+” symbol) are introduced into the plasma delivery vessel 150 at the center of the plasma plume 145. A tangential flow of a second gas 155 is introduced, by way of a dispenser 160, into the plasma delivery vessel 150 in such a manner as to induce a cyclonic flow within the vessel. The particles 105 are then collected in a collection vessel 180 and may then be subjected to additional, optional processing steps.

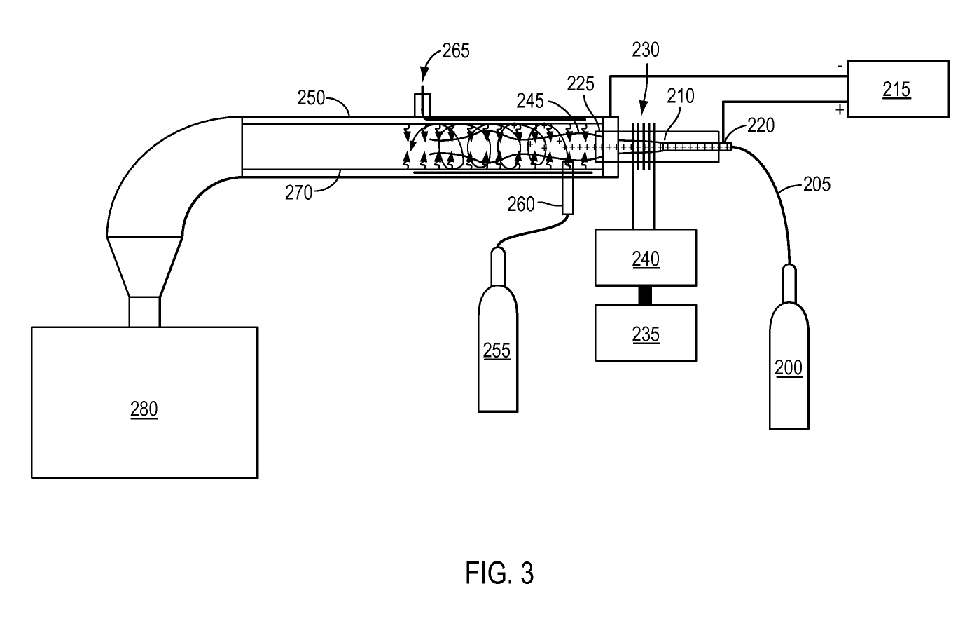

FIG. 3 illustrates an alternative exemplary embodiment, in which like numerals depict like items described in FIG. 2. In this embodiment, the feedstock particles 205 may comprise carbon feedstock particles alone or a mixture of carbon feedstock and at least one activating agent. A separate stream 265 comprising at least one activating agent is introduced into the plasma delivery vessel 250, where it can contact and react with the carbon feedstock. The plasma delivery vessel 250 may be equipped with a reactant delivery system 270, which may be a mesh or other device suitable for dispersing the stream 265 of activating agent at different locations along the plasma plume 245.

While FIGS. 2 and 3 illustrate embodiments for the chemical activation of carbon, it is also envisioned that the disclosed apparatuses can be used for the physical activation of carbon, e.g., using steam and/or CO₂. For instance, referring to FIG. 2 as an exemplary embodiment, the first gas 100 may be an inert gas such as nitrogen, argon, and the like, alone or in combination with steam or CO₂. Likewise, the feedstock particles 105 (which would, in this non-limiting embodiment, comprise carbon feedstock particles without activating agent) may be entrained in a gas such as steam or CO₂ or a mixture of one or both with an inert gas. The first gas 100 and feedstock particles 105 are introduced into the plasma containment vessel 110 and contacted with the plasma plume 145 for a time sufficient to convert the carbon into activated carbon. A similar method could be carried out with the apparatus of FIG. 3, wherein the separate stream 265 is either absent or comprises an inert gas and/or steam and/or CO₂, e.g., without activating agent.

The apparatuses described herein may employ, in various embodiments, a plasma plume produced by the combination of an RF inductively coupled plasma (ICP) and a DC non-transferrable arc plasma. RF induction typically provides a large volume of plasma, but the plasma may be highly turbulent. The DC arc plasma, on the other hand, tends to be more stable, having a substantially cylindrical/conical shape, but has a relatively small volume. Without wishing to be bound by theory, it is believed that the DC arc plasma may serve to stabilize the RF plasma and provide it with a substantially cylindrical cone shaped plume, while still maintaining a high volume of plasma.

An RF induction coil is disposed around the plasma containment vessel and connected to an RF matchwork for impedance matching and an RF generator. The RF generator may produce power at a frequency ranging from about 400 kHz to about 5.8 GHz. For instance, RF frequencies include 6.78 MHz, 13.56 MHz, 27.12 MHz, and 40.68 MHz, and microwave frequencies include 2.441 GHz and 5.800 GHz. For lower frequencies in the kHz range, a high frequency (>1 MHz) excitation may first be used, followed by the use of low frequency to maintain and operate the plasma. The RF generator power level may range from about 10 kW to about 1 MW, depending on the operation cost and throughput requirements. For example, the power level may range from about 50 kW to about 500 kW, or from about 100 kW to about 300 kW, including all ranges and subranges therebetween.

The plasma containment vessel is advantageously constructed out of a corrosion-resistant material, such as a high temperature ceramic material with high dielectric strength. An electrode runs through the center of the containment tube and may be constructed, for example, of molybdenum disilicide. The containment vessel may, in certain embodiments, comprise concentric interior and exterior chambers. The electrode bore runs through the length of the reactor in the interior chamber and the feedstock particles and first gas flow through this interior chamber. Surrounding the interior chamber, the exterior chamber may comprise an annulus of shield gas jets, which may be used for cooling the walls of the interior chamber. The shield gas jets may also provide additional plasma gas components to increase the plasma temperature, such as helium, argon, or nitrogen.

On the discharge side of the plasma containment tube, a stainless steel ring may be connected to the positive terminal (cathode) of the DC power supply. The electrode is connected to the negative terminal (anode) of the DC power supply. The DC power supply may be any device suitable for producing a DC arc plasma. For instance, a DC welding supply rated at 300 ADC at 64 VDC may be used, such as the Miller Goldstar 402 or an equivalent device.

In other embodiments, to further increase residence time, an inductive amplifier may be utilized to extend the length of the plasma. In such instances, an induction heating coil may be wrapped around the plasma containment vessel, which is coupled to an induction heating generator. The generator may operate at lower frequencies, such as less than 1 MHz, for example, 450 kHz, and a power rating ranging from about 10 kW to about 100 kW. Additional tangential inlets for the second gas may be included in the plasma delivery vessel to keep the cyclonic flow going down the length of the plasma plume.

The plasma containment vessel and/or plasma delivery vessel may have any shape or dimension and, in certain instances, may be tubular in shape. The plasma delivery vessel may advantageously be constructed of a durable material, such as 316 stainless steel. A water cooling jacket may be disposed around the outside of the plasma containment vessel and/or plasma delivery vessel, which may serve to keep the boundary region between the plasma plume outer edges and the vessel at a lower temperature.

The plasma plume may have any directional orientation but, in certain embodiments, may be a horizontal plasma plume, as illustrated in FIGS. 2 and 3. The core of the plasma can reach up to about 11,000° K, whereas the outer edge of the plasma can be as low as 300° K. The plasma plume may be at atmospheric pressure, in which case it may be characterized as an atmospheric pressure thermal plasma jet.

The feedstock particles may be fluidized by combining them with the first gas, e.g., the particles are entrained in the first gas. This stream is then fed into the plasma containment vessel, where the first gas is converted into a plasma and the feedstock particles are delivered into the center of the plasma plume to be optionally carbonized and activated.

In the plasma delivery vessel, a second gas is injected with a relatively high velocity in a direction tangential to the plasma plume, which produces a cyclonic flow around the plasma. The plasma and feedstock particles are twisted into a cyclonic pattern. Due to centrifugal force, which may be directly proportional to the second gas flow velocity, the particles are pushed to the outer edge of the plasma plume where temperatures are relatively lower. The flow velocity of the second gas may vary depending on the desired feedstock throughput and may, in certain embodiments, range from about 10 SLPM to about 200 SLPM, for example, from about 30 SLPM to about 150 SLPM, or from about 50 to about 100 SLPM, including all ranges and subranges therebetween.

Due to the cyclonic action, the feedstock particles can avoid long residence times in or near the higher temperature core where the particles could potentially vaporize. Additionally, the cyclone, coupled with the forward velocity of the plasma plume, can drive the activated particles out of the plume and into a collection vessel, such as a hermetically sealed collection chamber. For instance, a fine mesh may be used to collect the particles. The particles may accumulate on the mesh for a period of collection, after which the mesh is shaken and/or blasted with inert gas to move the particles into the collection vessel. Any gas in the collection chamber can optionally be separated, filtered, and returned back to the beginning of the process.

The apparatus described herein may be operated under tightly contained conditions, which may provide for a product with a high degree of purity. In addition, the rapid thermal transfer achieved by using a plasma can dramatically reduce residence times for activation, thereby increasing throughput. The potential to combine the steps of carbonization and activation of carbon precursors provides even further time and cost savings. Moreover, the RF-DC hybrid plasma technology operates at a relatively low cost and is not prone to mechanical failures, thus decreasing down time and operational costs. While prior art plasma particulate processes rely on free fall velocity of the particles through the plasma, the methods and apparatuses disclosed herein utilize a cyclonic flow to increase residence time, allowing for sufficient time for the carbonization and/or activation of the feedstock particles. Finally, while prior art methods may employ low pressure, low temperature, and low power levels, the methods and apparatuses disclosed herein utilize plasma at atmospheric pressure and/or high temperature and/or high power levels with a unique cyclonic flow pattern so as to achieve a temperature and residence time suitable for the carbonization and/or activation of feedstock particles.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “an activating agent” includes examples having two or more such “activating agents” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Other than in the Example, all numerical values expressed herein are to be interpreted as including “about,” whether or not so stated, unless expressly indicated otherwise. It is further understood, however, that each numerical value recited is precisely contemplated as well, regardless of whether it is expressed as “about” that value. Thus, “a temperature greater than 25° C.” and “a temperature greater than about 25° C.” both include embodiments of “a temperature greater than about 25° C.” as well as “a temperature greater than 25° C.”

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a carbon feedstock that comprises a carbonized material include embodiments where a carbon feedstock consists of a carbonized material, and embodiments where a carbon feedstock consists essentially of a carbonized material.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An apparatus for the chemical activation of carbonaceous materials, comprising:
(i) a plasma containment vessel;
(ii) a coil disposed around the plasma containment vessel and configured for current flow within the coil;
(iii) a plasma delivery vessel connected to the plasma containment vessel;
(iv) a first dispenser disposed to introduce a first stream comprising a first gas and feedstock particles into the plasma containment vessel, wherein the feedstock particles comprise a carbon feedstock and, optionally, at least one activating agent;
(v) a second dispenser disposed to introduce a tangential flow of a second gas into the plasma delivery vessel;
(vi) an optional third dispenser disposed to introduce the at least one activating agent into the plasma delivery vessel;
(vii) a radio-frequency generator connected to the at least one coil and configured to produce a radio-frequency current flow within the coil; and
(viii) a direct current supply connected to the plasma containment vessel,
wherein the radio-frequency and direct currents together are sufficient to convert the first gas into a plasma, and
wherein the at least one activating agent is introduced by the first dispenser and/or the third dispenser.

2. The apparatus of claim 1, further comprising a cooling jacket disposed around the plasma containment vessel and/or the plasma delivery vessel.

3. The apparatus of claim 1, wherein the plasma containment vessel comprises an interior chamber and an exterior chamber, wherein:
(a) the feedstock particles and first gas flow through the interior chamber, and
(b) the exterior chamber optionally comprises a shield gas.

4. The apparatus of claim 1, wherein the plasma is an ambient pressure plasma and the plasma plume has a length and circular cross-section defining a core and an outer edge, and wherein the plasma plume has a temperature gradient ranging from greater than about 11,000° K at the core to greater than about 300° K at the outer edge.

5. The apparatus of claim 1, wherein the current flow in the coil has a frequency ranging from about 400 kHz to about 5.8 GHz.

6. The apparatus of claim 1, wherein the radio-frequency generator operates at a power level ranging from about 10 kW to about 1 MW.

7. The apparatus of claim 1, wherein the plasma flows into the plasma delivery vessel in a first direction, and wherein the second dispenser is disposed to deliver the second gas in a second direction tangential to the first direction, and wherein the feedstock particles flow in a cyclonic pattern in the plasma delivery vessel.

8. The apparatus of claim 1, wherein the first and/or second gases are chosen from argon, air, helium, nitrogen, mixtures thereof, and their mixtures with steam.

9. The apparatus of claim 1, wherein the first and/or second gases have a flow rate ranging from about 10 SLPM to about 200 SLPM.

10. The apparatus of claim 1, further comprising an impedance matching device connected to the radio-frequency plasma generator and the coil.

11. A method for forming activated carbon, said method comprising:
generating a plasma plume;
introducing feedstock particles comprising a carbon feedstock and at least one activating agent into the plasma plume;
wherein the feedstock particles flow in a cyclonic pattern within the plasma plume, and
wherein the feedstock particles are in contact with the plasma plume for a time period sufficient to react the at least one activating agent with the carbon feedstock to produce activated carbon.

12. The method according to claim 11, wherein the carbon feedstock is chosen from carbon precursor materials and carbonized materials.

13. The method according to claim 12, wherein the carbon precursor materials are in contact with the plasma plume for a time period sufficient to carbonize the carbon precursor materials.

14. The method according to claim 11, wherein the at least one activating agent is chosen from KOH, NaOH, LiOH, H₃PO₄, Na₂CO₃, NaCl, MgCl₂, AlCl₃, P₂O₅, K₂CO₃, KCl, ZnCl₂, and mixtures thereof.

15. The method according to claim 11, wherein introducing the feedstock particles into the plasma plume comprises one of:
(a) combining the carbon feedstock and the activating agent to form a feedstock mixture, and introducing the feedstock mixture into the plasma plume; or
(b) separately introducing the carbon feedstock and the activating agent into the plasma plume; or
(c) combining the carbon feedstock and the activating agent to form a feedstock mixture, introducing the feedstock mixture into the plasma plume, and separately introducing the feedstock mixture and an additional activating agent into the plasma plume, wherein the additional activating agent may be identical to or different from the activating agent.

16. The method according to claim 11, wherein the feedstock particles are entrained in a first gas chosen from argon, air, helium, nitrogen, mixtures thereof, and their mixtures with steam.

17. The method according to claim 11, wherein the plasma plume flows in a first direction, and wherein the method further comprises contacting the plasma plume with a second gas flowing in a second direction tangential to the first direction.

18. The method according to claim 17, wherein the second gas is chosen from argon, air, helium, nitrogen, mixtures thereof, and their mixtures with steam.

19. The method according to claim 11, wherein the plasma plume heats the feedstock particles to an activation temperature ranging from about 600° C. to about 900° C. for a time period of less than or equal to about 10 seconds.

20. The method according to claim 11, further comprising at least one step chosen from collecting the activated carbon, holding the activated carbon at the activation temperature, cooling the activated carbon, and/or rinsing the activated carbon.
